(19) United States
(12) Patent Application Publication
(10) Pub. No.: US 2019/0387752 A1
(43) Pub. Date: Dec. 26, 2019

(54) ENERGY HARVESTING BURNER FOR COOKTOP

(71) Applicant: Eric Robert Krohn, Binghamton, NY (US)

(72) Inventor: Eric Robert Krohn, Binghamton, NY (US)

(21) Appl. No.: 16/014,347

(22) Filed: Jun. 21, 2018

(51) Int. Cl. A21B 1/44; A47J 37/04

(52) U.S. Cl. CPC A21B 1/44; F24C 3/082; A47J 37/046

(57) ABSTRACT

A gas burner appliance for recycling wasted heat from a heating process and for distributing heat evenly to a vessel or product. A housing is provided and a plate for directly collecting wasted heat is supported by the housing. A burner arm is also supported by the housing and disposed above the plate for receiving and combusting premixed fuel for uniformly distributing heat to the plate. A motor is supported by the housing and a drive mechanism connects the motor to the burner arm. A thermal electric generator generates electricity directly from heat of the plate and provides at least some of the generated electricity to the motor.

### RELATED PATENT APPLICATION

The present application is related to provisional patent application No. 61/987,523, for ENERGY HARVESTING GAS BURNER filed May 2, 2014 and U.S. patent application Ser. No. 14/708,388 for ENERGY HARVESTING GAS BURNER filed May 11, 2015, now abandoned, and hereby incorporates the teaching therein by reference.

### FIELD OF THE INVENTION

This invention relates to gas burner appliances for use in home, commercial, and laboratory heating or cooking applications and, more particularly, to a burner that uses a gas supply and room air that converge, mix, and combust to heat either a vessel or a product.

### BACKGROUND OF THE INVENTION

The present inventor realized that wasted heat (that not absorbed by the item being heated) accounts for some 78% of the heat from a flame. In other words, only 22% of the heat applied to a vessel or product on a conventional stove is actually absorbed by the cookware.

Traditional burners provide heat concentrations which are stagnant when being utilized. While traditional burners may be able to output low BTU by allowing very little flame to be used, what flame is produced will continue to heat only a concentrated area. In addition there is a limit to how low the fuel flow can be in burner ports before combustion stops; thus there is a lower limit to the amount of heat produced and this lower limit can heat a vessel excessively so that the product burns. These problems create hot spots and could lead to over consumption of fuel when attempting delicate or prolonged heating, which in turn ruins the product or heating vessel.

Stove designers in the past have attempted to rotate the burner ports utilizing outside power sources or compressed gas. These designs, however, lack energy recycling mechanisms, are not able to be retrofitted to a variety of gas sources, and generally have complicated mechanical designs that are expensive and prone to malfunction.

Recently, the trend of burners has concentrated flames towards a central point. Often the low-BTU flame is centered in the burner and heats only the center of the cooking vessel. An excess of heat applied to any one location leads to a poor distribution of heat. In all variations of flame distribution design, the heat remains in a stable position, creating hotspots on the cooking vessel or item.

These burners have represented the main style for many years. However, due to limitations inherent in their design, these burners create hotspots on pans, and provide an abundance of heat that is often wasted or burns the vessel or product being heated. This excess use of energy is a drain on fossil fuel consumption. The present invention allows the user to help prevent overconsuming fuel, thus creating less of a drain on fossil fuels.

Millions of dollars every year are spent on cookware that boasts improved ability to effectively distribute heat in order to prevent burning, scorching, and uneven cooking. As long as flames are concentrated at small areas of cookware, however, uniform heating cannot be accomplished. By rotating the heating source the burner effectively prevents uneven heating and overheating any one area on any cookware material.

### DESCRIPTION OF RELATED ART

U.S. Pat. No. 6,250,210 issued to Moreth for HIGH EFFICIENCY CAROUSEL INFRARED OVEN issued on Jun. 26, 2001, describes a high efficiency carousel pizza oven that is an oven of the open cavity or open input type which permits food access and fluid communication with the atmosphere through a proximal or front opening within the oven housing. The oven employs a solid rotating thermal reservoir in the nature of a circular panel capable of storing large amounts of thermal energy per unit of mass. Rotation of the panel assures that hot spots will not develop thereby eliminating scorching of food items cooked thereon. Provided beneath the panel, in thermal communication therewith, and preferably along a radius thereof situated substantially normal to an axis of rotation of the panel, is a flame burner which furnishes greater heat to the panel as a function of increase in distance from the axis to thereby provide cooking of uniform heating to the rotating panel as a function of increase in circumference relative to distance from the axis.

U.S. Pat. No. 5,575,638 issued to Witham, et al. for STOVE BURNER SIMMER CONTROL issued on Nov. 19, 1996, describes a pulsed flame sequence burner control in response to a user's selective manipulation of an actuator through a range of response. A microcontroller-based control module switches both a burner ignitor control and an electric valve for gas supply to the burner in a predetermined time sequence depending upon the actuator position. Preferably, one or more of a plurality of burners on a single cooking top are controlled for pulsed sequence operation, and a single actuator for each channel, preferably in a form of a rotary knob, provides a simple user interface for utilizing the pulsed flame sequence, preferably in a low gas flow or simmer cooking range.

U.S. Pat. No. 6,439,881 issued to Haynes, et al. for SPIRAL-SHAPED ATMOSPHERIC GAS BURNER issued on Aug. 27, 2002, describes an atmospheric gas burner with a spiral-shaped burner body. A plurality of ports is formed in the burner body so as to be in fluid communication with the burner's internal chamber. Preferably, the burner body includes a substantially cylindrical hub section and an arm section that is joined at one end to the hub section and bends around the hub section.

U.S. Pat. No. 3,358,736 issued to Reed, et al. for ROTARY GAS BURNER ASSEMBLY issued on Dec. 19, 1967, describes a rotary burner head having discharge ports therein so that fuel issuing therefrom rotates the burner head. The burner housing is formed to present an annular ledge adjacent the arcuate path of movement of the burner head. Means are provided to deliver a small amount of fuel to the ledge where it burns stably to maintain ignition of the main portion of fuel.

U.S. Pat. No. 7,083,123 issued to Molla for INTERNAL FLAME GAS BURNER WITH HIGH COMPACTNESS issued on Aug. 1, 2006, describes an internal flame gas burner comprising a gas injector, a vacuum tube, and an annular chamber formed by a pot covered by a cap, the chamber having an internal edge perforated with flame exit ports, and the tube having a convergent section open to the ambient air at an inlet end, and a divergent section succeeding the convergent section, ending at the outlet of the tube and opening out into the chamber, the injector being relatively closer to the inlet of the tube than to the outlet.

U.S. published patent no. 2003/0087214 on an application filed by Wilton, et al. for CONTROLLED FLAME GAS BURNER published on Jan. 9, 2001, describes multiple fingered burner including controls for continuity of gas flow and ignition throughout all of the ports peripherally positioned around the contoured wall of the burner body. A plurality of burner parts is nested together with an indexer limiting insertion to at least one predetermined alignment in order to avoid improper fit or alignment between adjacent burner parts. In addition, the peripherally positioned ports are covered by a laterally extending lip of a cap, and at least one of the parts includes recesses adjacent the laterally extending lip to provide ignitable gas flow passages along the peripheral wall of the burner that maintain continuity of ignition at adjacent burner ports.

U.S. Pat. No. 2,646,788 issued to Locke for ROTARY GAS BURNER issued on Jul. 28, 1953, describes a domestic cooking stove for cooking with gas fuel, comprising a stationary frame having a support for a cooking utensil, a stationary gas supply pipe terminating in an upwardly directed discharge end beneath the support, a rotatably mounted tube extending substantially vertically, bearings operatively interposed between the frame and the tube for supporting the tube in rotatable relation to the frame, the lower end of the tube loosely embracing the upper end of the supply pipe in spaced and non-contacting relation thereto to provide a free space for entrance of air between the supply pipe and the tube.

U.S. published patent application no. 2007/0281267 on an application filed by Li for BURNER HEAD FOR A GAS STOVE published on Dec. 6, 2007, describes a burner head for a gas stove that can provide even-burning fire flames. The burner head for a gas stove comprises a base and an annular cover, which is characterized in that small holes through inner and outer surroundings of the annular cover are disposed at a lower portion of the annular cover and gas-exiting grooves through the inner and outer surroundings of the annular cover are disposed at an upper portion of the annular cover.

U.S. Pat. No. 3,131,685 issued to Bergfield for GRILLE ROTATOR issued on May 5, 1964, describes means providing rotating movement to the conventional types of grilles ordinarily used in preparing meats for consumption as foods. The conventional types of grilles are composed of a pan-like member supported by leg members, with the pan member being adapted to contain fuel such as charcoal. The meat-receiving grille is formed of wire mesh construction and is positioned in rotatable relation with the pan by means of a center post extending downwardly through the center of the pan. A height-adjusting lever is also provided for raising and lowering the grille with relation to the pan member with the inner end of the lever being adapted to bear against the lower end of the center post. The height-adjusting lever is further provided with a ratchet or similar device for maintaining the desired height adjustment of the grille through the center post.

U.S. published patent application no. 2014/0020730 on an application applied for by Imran, for SYSTEM FOR THERMOELECTRIC ENERGY GENERATION, published on Jan. 23, 2014, describes systems and methods for generating and delivering electricity and/or hot water for combined heat and power (CHP) using one or more fuels. A control system can be configured to monitor household electrical usage and dynamically regulate the system to operate at maximum efficiency as well as sell power to an external grid. The energy generation system includes a cold water input and a hot water output to create a temperature difference or gradient, none of which are required or used in the present invention. The present invention simply does not require water to generate electricity.

### SUMMARY OF THE INVENTION

In accordance with the present invention, there is provided a gas burner appliance for recycling wasted heat from a heating process and for distributing heat evenly to a vessel or product. A housing is provided and a plate for directly collecting wasted heat is supported by the housing. A burner arm is also supported by the housing and disposed above the plate for receiving and combusting premixed fuel for uniformly distributing heat to the plate. A motor is supported by the housing and a drive mechanism connects the motor to the burner arm. A thermal electric generator generates electricity directly from heat of the plate

The burner is unique in its ability to recycle wasted heat from the heating process and to convert it into electricity. The appliance rotates the heating body horizontally to a cooking vessel, thus allowing for prolonged low-BTU output without adding excessive heat to any single location. The motion of the burner performs without adding an energy source or mechanical device, allowing the burner to be retrofitted to a variety of gas sources. The burner consists of a housing, electric motor, and a thermal energy generator that acts as an energy harvesting device. However, any materials that harvest energy to create electricity can be used. A rotating burner arm provides the outlet for combustion.

It is therefore an object of the invention to provide a mechanism to harvest energy in a heating process.

It is a further object of the present invention to provide a mechanism to rotate a heating element via energy harvesting, thus providing power to a motor.

It is a further object of the present invention to provide a mechanism to self-autonomously operate a heating appliance, the mechanism being self-contained.

It is a further object of the present invention to provide a mechanism to utilize thermal gradient in a heating process to produce electricity.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a schematic block diagram of the burner with housing and mechanical and electrical parts in accordance with the present invention.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

In accordance with one aspect of this invention, a burner support is attached to a stovetop base by means well known in the art. The burner support houses an electric motor that, via a linkage, rotates a “T” shaped burner arm. A thermal energy generator is used to harvest wasted heat to produce electricity, which is used to power the motor.

In accordance with another aspect of this invention a thermal energy generator (TEG) is used to harvest the heat that is not readily absorbed by the cook vessel or item. This burner is not limited to this specific form of electrical generation and may include metals/alloys or other mechanics of converting forms of energy into electricity.

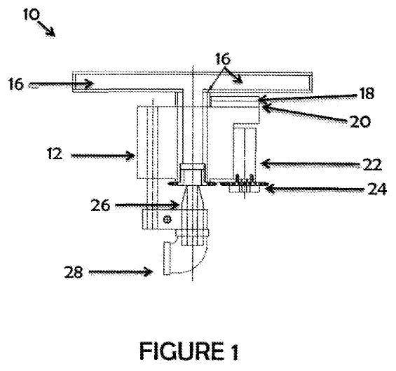

Referring now to FIG. 1, there is shown a schematic block diagram of the burner appliance, generally shown as reference numeral 10, of the present invention. A burner housing 12 attaches to a cooktop 14 by a variety of possible means well known to those skilled in the art. Housing 12 contains and supports the components of the burner 10, described in greater detail hereinbelow.

Disposed below rotating burner arm 16 is a plate 18. Plate 18 is constructed of ceramic material in the preferred embodiment, although any suitable heat-conveying material can be used. A burner arm 16 can rotate while it combusts a gas and air mixture. The rotation of burner arm 16 applies substantially uniform heat directly to plate 18.

Plate 18 aids in transferring wasted heat to a thermal energy generator (TEG) 20 that produces electricity from wasted heat energy. TEG 20 utilizes heat traveling from one side of the device to a cold side in accordance with the Seebeck thermoelectric effect to create electricity. TEG 20 is shown in FIG. 1 beneath burner arm 16, but TEG 20 may be placed at any appropriate, functionally equivalent location and still be within the scope of the invention. A suitable TEG device sold under the trademark EverGen is available from II-IV Marlow Company in Dallas, Tex.

A motor 22 is also located in housing 12. In the preferred embodiment, motor 22 is preferably a 3-6-volt DC high torque motor manufactured by Tinkering Supplies Company as Model No. H04469-01J, but motor 22 need not be electric and still be within the scope of the present invention.

Connecting electric motor 22 to burner arm 16 is a linkage 24, preferably a chain and sprocket manufactured by McMaster-Carr Company as Model Nos. 6789K47 and 7142k1. Alternatively, a direct drive motor 22 and burner arm 16 can be provided to accomplish the same task: rotating burner arm 16 above plate 18 to provide uniform heat thereto. Other linkages can be used, as are well known to those skilled in the art.

Disposed beneath housing 12, as part of a stove or cooktop (not shown), is a gas/air mixing component 26 for mixing fuel and supplying the fuel to burner arm 16, which combusts the fuel for proper operation of burner 10.

Supplying gas to gas/air mixing component 26 is a gas inlet 28. Gas/air mixing component 26 is preferably manufactured by CTM-Corp. for this invention.

In operation, gas is introduced into the burner gas inlet 28. As the gas rises to gas/air mixing component 26, it is allowed to mix with room air. The premixed gas/air mixture enters housing 12. When gas/air mixture leaves the orifices of burner arm 16, it is combusted and used for heating applications.

Due to the inefficiencies of the heating process TEG 20 is utilized. Plate 18, secured above TEG 20, becomes hot, collecting wasted heat. Electricity generated by TEG 20 is applied to motor 22, which turns linkage 24 connected to rotating burner arm 16.

It can be appreciated that the inventive technology reduces the amount of gas used by the user, making the burner an energy saver for both home and commercial applications. Since the intent is to reduce the amount of heat delivered to the pan bottom, this rotary burner uses less gas than conventional simmer burners, resulting in cost savings and reduced use of natural resources. In addition, due to the rotating heating body, the burner provides improved evenness of cooking, saving food loss.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

While only a few exemplary embodiments have been described, those knowledgeable in this science will easily appreciate that many modifications are possible in the exemplary embodiments without materially departing from the novel and unique advantages of this disclosure. Accordingly, all such modifications and alternative are intended to be included within the scope of the invention as defined in the following claims. Those skilled in this science should recognize that such modifications and equivalent constructions or methods do not depart from the spirit and scope of the present disclosure, and that they may make various changes, substitutions, and alterations herein without departing from the spirit and scope of the present disclosure.

Having thus described the invention, what is desired to be protected by Letters Patent is presented in the subsequently appended claims.

What is claimed is:

1. A gas burner appliance for recycling wasted heat from a heating process and for distributing heat evenly to a vessel or product, comprising:
a) a housing;
b) a plate for directly collecting wasted heat, said plate supported by said housing;
c) a burner arm supported by said housing and disposed above said plate for receiving and combusting premixed fuel for uniformly distributing heat to said plate;
d) a motor supported by said housing;
e) drive means operatively connecting said motor to said burner arm; and
f) a thermal electric generator for generating electricity directly from heat of said plate and for providing at least some electricity to said motor for the operation thereof.

2. The gas burner appliance in accordance with claim 1, wherein said drive means comprises a chain and sprocket.

3. The gas burner appliance in accordance with claim 1, further comprising an inlet for providing combustible gas to said gas burner appliance.

4. The gas burner appliance in accordance with claim 3, further comprising a gas/air mixing component operatively connected to said burner arm for premixing fuel prior to the combustion thereof.

5. The gas burner appliance in accordance with claim 3, wherein said gas burner appliance is disposed on a gas stove.

6. A gas burner appliance for recycling wasted heat from a heating process and for distributing heat evenly to a vessel or product, comprising:
a) a rotatable burner arm for receiving and combusting premixed fuel;
b) a plate disposed below said burner arm for directly collecting wasted heat;
c) a motor for rotating said rotatable burner arm; and
d) a thermal electric generator proximate said plate for generating electricity directly from heat of said plate and for providing at least some electricity to said motor for the operation thereof.

7. The gas burner appliance in accordance with claim 6, further comprising a chain and sprocket linkage between said electric motor and said rotatable burner arm.

8. The gas burner appliance in accordance with claim 6, further comprising an inlet for providing combustible gas to said gas burner appliance.

9. The gas burner appliance in accordance with claim 8, further comprising a gas/air mixing component operatively connected to said burner arm for premixing fuel prior to the combustion thereof.

10. The gas burner appliance in accordance with claim 8, wherein said gas burner appliance is disposed on a gas stove.

11. The gas burner appliance in accordance with claim 6, wherein said motor comprises an electric motor.
